(19) United States
(12) Patent Application Publication
(10) Pub. No.: US 2009/0309728 A1
(43) Pub. Date: Dec. 17, 2009

(54) OBJECT DETECTION METHOD AND OBJECT DETECTION SYSTEM

(75) Inventor: Shinya Yamamura, Fukuoka (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/547,190

(22) Filed: Aug. 25, 2009

Related U.S. Application Data
(63) Continuation of application No. PCT/JP2007/055449, filed on Mar. 16, 2007.

(51) Int. Cl. G08B 13/14

(52) U.S. Cl. 340/568.1

(57) ABSTRACT

An object detection method is executed by an object detection system for detecting data corresponding to a specific object in data received from sensors. The system includes a plurality of monitors, an application device, and a data accumulator. The method includes the followings. The application device specifies reference data corresponding to the specific object. Each of the plurality of monitors samples data received from a sensor to generate and transmit sampled data. The data accumulator analyzes sampled data received from each of the plurality of monitors in accordance with an analysis logic to generate first analyzed data. The data accumulator determines whether the first analyzed data matches the reference data specified by the application device. The data accumulator transmits a detection notification to the application device when analyzed data generated from sampled data received from a monitor out of the plurality of monitors has matched the reference data.

### CROSS-REFERENCE TO RELATED APPLICATION

This is a Continuation application, which is based upon and claims the benefit of priority of the prior International Application No. PCT/JP2007/055449, filed on Mar. 16, 2007, the entire contents of which are incorporated herein by reference.

### FIELD

The embodiments discussed herein are related to an object detection system which detects data of a specific target object such as a specific sound or a specific image in data collected by a device such as a microphone or a camera.

### BACKGROUND

Recently, security service systems have been put into the practical use, which use data collected by a device such as a microphone or a camera and are activated upon detecting occurrence of sound or change in video image. Further, detection of a target object by specific devices holding data for detecting the target object has been widely distributed. Such devices include a voice recognition device and an automatic checkout counter for restaurant, which employs optical scan, and the like.

Methods for monitoring a target location with high reliability at low cost have been also developed (see, for example, PCT Japanese Translation Patent Publication No. 2003-518679).

Such methods are executed, for example, by a monitoring system including a plurality of monitoring modules each having an optical sensor for monitoring the target location, and attended by an operator at a remote monitoring station. Such methods include, for example, capturing an image of the target location monitored by the respective monitoring module, extracting from the captured image a region different from a reference image recorded in the respective monitoring module, extracting a target object from the region in the respective monitoring module, classifying the target object in accordance with the type, size, shape and/or motion record that relate to a human target object to be informed about in the respective monitoring module, transmitting data indicating the region to the monitoring station in a formalized manner when the target object is classified as a human target object to be informed about, and certifying the human target object to be informed about by replaying the transmitted data at the monitoring station to display the same to the operator.

An environmental sound which contains various types of sound collected by a sound collection microphone, or a video image which contains various target objects picked up by a video camera may not be recognized as a human voice or a simple image like table ware, for example. Sophisticated object detection technology is inevitable for an application device to detect desired data specific thereto in such an environmental sound or such a video image. Monitors provided with such a function may require high computational power, resulting in high cost.

This may pose a problem when constructing a system to automatically detect a human in accordance with a breaking sound of a glass or a door when someone breaks in, or an image picked up by a monitor camera in a security service, for example. In a building control system, such devices are required to be installed for each floor or each tenant. Therefore, employment of costly monitors may make no realistic sense to reduce the labor cost through automatization.

To provide services for detecting a specific target object in an environmental sound or an environmental image, it is required to clarify what to be detected or what to be monitored and a system may be configured to detect such a sound or such a target object. FIG. 11 is a diagram illustrating an example of a conventional object detection system. The monitor 1 is connected to an application device 3, which is a computer executing an application program, via the communication means such as Universal Serial Bus (USB) and Recommended Standard 232 version C (RS-232C) or the Internet Protocol (IP) network based on Local Area Network (LAN) or wireless transmission. When there are two application devices, for example, for detecting different target objects as illustrated in FIG. 11, the two application devices 3 may collect data through different systems because the monitors 1 are specially adjusted for respective application programs. In such a configuration, additional monitors may be provided in the same location when another application device or an application program is added, resulting in the cost increase and inefficiency.

### SUMMARY

According to an aspect of the present invention, provided is an object detection method executed by an object detection system for detecting data corresponding to a specific object in data received from sensors. The object detection system includes a plurality of monitors, an application device, and a data accumulator. The object detection method includes the followings.

The application device specifies reference data corresponding to the specific object.

Each of the plurality of monitors samples data received from a sensor to generate and transmit sampled data.

The data accumulator analyzes sampled data received from each of the plurality of monitors in accordance with an analysis logic to generate first analyzed data.

The data accumulator determines whether the first analyzed data matches the reference data specified by the application device.

The data accumulator transmits a detection notification indicating detection of the specific object to the application device when first analyzed data generated from sampled data received from a first monitor out of the plurality of monitors has matched the reference data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system configuration of an object detection system according to an embodiment of the present invention;

FIG. 2 is a functional block diagram illustrating an example of a functional configuration of an object detection system according to an embodiment of the present invention;

FIG. 3 is a diagram illustrating an example of a data structure of a data buffer of a monitor according to an embodiment of the present invention;

FIG. 4 is a diagram illustrating an example of a data structure of a data buffer of a data accumulator according to an embodiment of the present invention;

FIG. 5 is a diagram illustrating an example of a data structure of an application management record stored in an application management storage of a data accumulator according to an embodiment of the present invention;

FIG. 6 is a diagram illustrating an example of a data structure of a pattern record stored in a pattern library of a data accumulator according to an embodiment of the present invention;

FIGS. 7A-7E are diagrams illustrating an example of a process for specifying a target object using a registered reference data pattern according to an embodiment of the present invention;

FIGS. 8A-8D are diagrams illustrating an example of a process for specifying a target object by registering a new reference data pattern according to an embodiment of the present invention;

FIG. 9 is a diagram illustrating an example of an operation flow of a process for a sound data analysis performed by a data accumulator according to an embodiment of the present invention;

FIG. 10 is a diagram illustrating an example of an operation flow of a process for a detailed sound data analysis performed by an application device according to an embodiment of the present invention; and

FIG. 11 is a diagram illustrating an example of a conventional object detection system.

### DESCRIPTION OF EMBODIMENTS

There are various types of target objects to be monitored depending on service usage. Unlike simple sensors such as an optical sensor and a temperature sensor, monitors of this type may be required to be finely adjusted for detecting the target objects. Thus, such a situation may be easily foreseen that requires an additional target object or change in the sampling condition after starting the service.

The above-discussed methods for monitoring the target location may be designed to allow the monitoring modules to perform specific operations, thus failing to solve the above-discussed problems.

As discussed above, the use of hardware coded monitors as in related arts is not efficient in a service for detecting a specific sound or video image in environmental data that contains various types of data. The convenience of such a service may be improved constitutionally, by correlating the sampled data with the target object name. The correlation allows the operator to readily specify a target object such as alarm-A and a ringtone of a telephone, which makes it possible to perform search for a target object or registration of a new target object.

Accordingly, it is preferable to provide an object detection system that may solve problems discussed above.

The embodiments discussed herein are related to a technology which allows an application device for detecting a specific sound or video target object in a single data source containing data such as sounds or video images collected by a microphone or a camera to specify various target objects and collect data in accordance with application usages by using versatile data collection devices without requiring data collection devices specific to the application device.

The embodiments allow an application device to detect a specific target object in data of sounds or video images using versatile monitors without using monitors specific to the application device. The application device may be designed to freely specify and register a target object so as to further increase the convenience of the service.

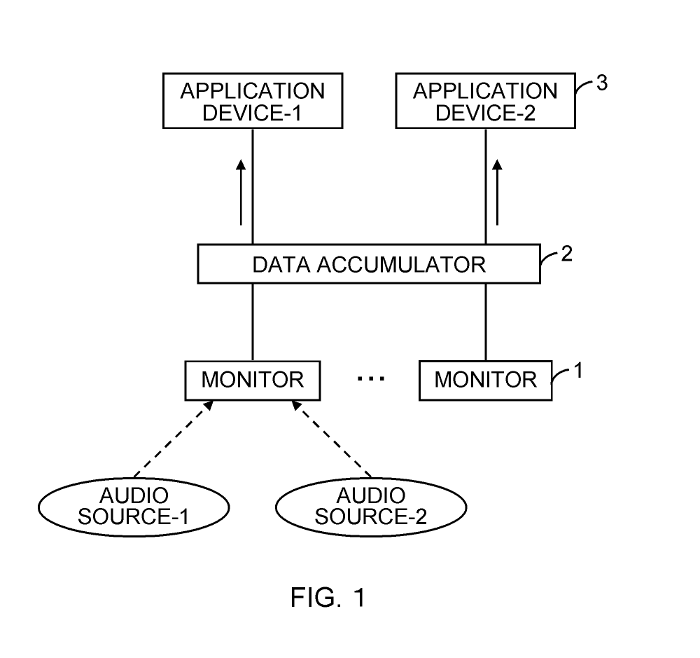

FIG. 1 is a diagram illustrating an example of a system configuration of an object detection system according to an embodiment of the present invention. The object detection system according to the embodiment includes a monitor 1, a data accumulator 2, and an application device 3. The monitor 1 is connected to the data accumulator 2 via communication means such as USB and RS-232C or IP network based on LAN or wireless transmission. The application device 3 is, for example, a personal computer (PC) executing an application program. The computer constituting the application device 3 is connected to the monitor 1 and the data accumulator 2 via the IP network based on LAN or wireless transmission.

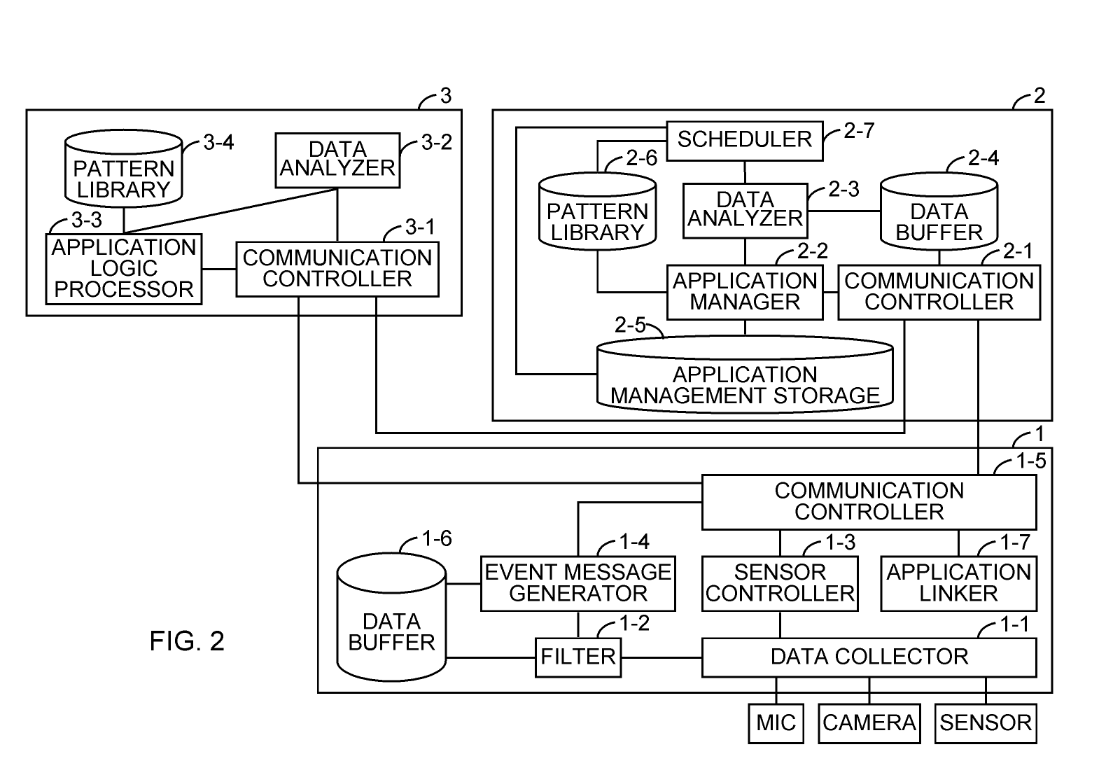

FIG. 2 is a functional block diagram illustrating an example of a functional configuration of an object detection system according to an embodiment of the present invention.

The monitor 1 includes sensor equipment such as a microphone (denoted by “MIC” in the drawings) for collecting sounds and a camera for picking up images, and converts analog data of sounds or images into digital data so as to be transmitted to the data accumulator 2 or the application device 3.

The monitor 1 includes a data collector 1-1, a filter 1-2, a sensor controller 1-3, an event message generator 1-4, a communication controller 1-5, a data buffer 1-6, and an application linker 1-7.

The data collector 1-1 is connected to such equipment as a microphone, a camera and a sensor via communication cables or wireless interfaces complying with various standards, and performs analog to digital conversion for converting analog data collected by the equipment into digital data. The data collector 1-1 transmits a command for adjusting sensitivity or focus of the microphone or the camera to the equipments via the communication interface in accordance with an instruction from the sensor controller 1-3.

The filter 1-2 removes a peripheral environmental sound of the monitor 1 from the digitalized data, or makes voice data and figure data of a human ambiguous in consideration with the privacy. In a case of a sound, for example, a digitally sampled sound is further decomposed into a spectrum to remove a spectrum of frequencies corresponding to human voice and a spectrum regarded as an environmental noise. In a case of an image, data corresponding to a region recognized as a human is subjected to a mosaic process. The filter may remove sampled audio data determined as being silent so as to reduce transmission data.

The sensor controller 1-3 provides an application programming interface (API) for the application device 3 and the data accumulator 2 to control the microphone, the camera, and the sensor connected to the monitor 1.

The event message generator 1-4 generates an event message from the sampled data stored in the data buffer 1-6, and transmits the generated event message to the data accumulator 2 at a constant interval.

The communication controller 1-5 transmits the event message to the data accumulator 2 using a predefined protocol via the interface such as USB, RS-232C, LAN, and wireless LAN. The communication controller 1-5 receives remote activation from the application device 3 through an API provided by the application linker 1-7.

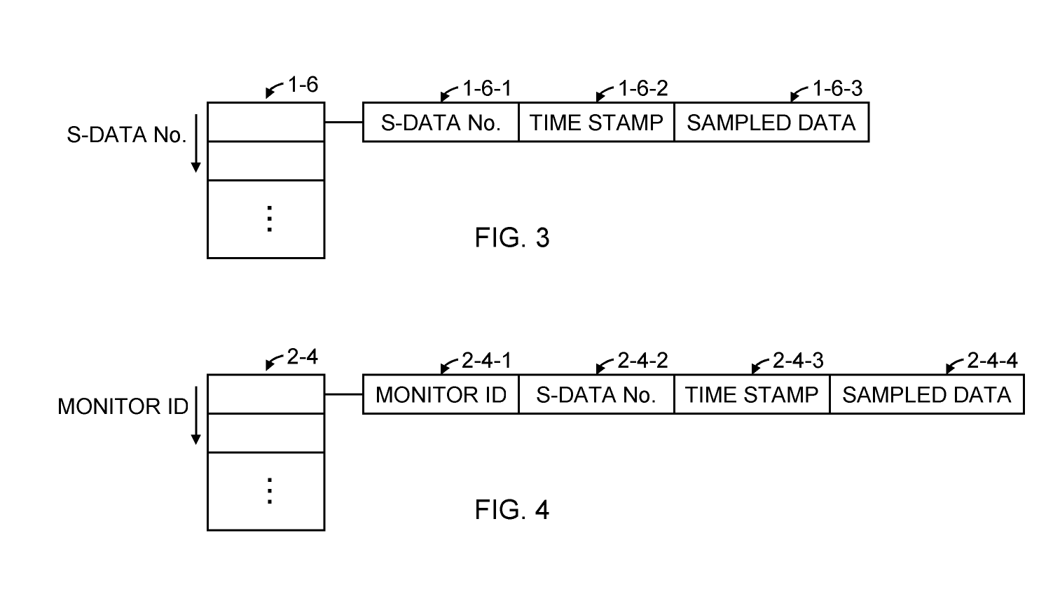

The data buffer 1-6 stores sampled data sampled by the data collector 1-1 and filtered by the filter 1-2. FIG. 3 is a diagram illustrating an example of a data structure of a data buffer of a monitor according to an embodiment of the present invention. The data buffer 1-6 stores a sampling record including a sampled data number (denoted by “S-DATA No.” in the drawings) field 1-6-1, a time stamp field 1-6-2, and a sampled data field 1-6-3.

The sampled data number field 1-6-1 contains a sampled data number capable of identifying the sampled data.

The time stamp field 1-6-2 contains a time stamp indicating the sampling time.

The sampled data field 1-6-3 contains the sampled data.

The sampling record is stored in the data buffer 1-6 for a predefined time period, and then the sampling record is removed from the data buffer 1-6. Because, the process for detecting a sound or image generally requires information on the start position of the sampled data and the image differential on the time-series, and there is a case that old sampled data is required to detect a target object.

The application linker 1-7 provides an API for receiving a command to start a test sampling, a command for data reference, and a command for controlling equipments from the application device 3. The application linker 1-7 extracts data from the data held by the monitor 1 and allows the functional blocks to operate in accordance with the command received from the application device 3.

The data accumulator 2 receives an event message periodically transmitted from the monitor 1, and compares the sampled data contained in the event message with reference data preliminarily stored in the data accumulator 2. When the sampled data matches the reference data, the data accumulator 2 transmits a detection notification message indicating the match to an application device 3 that requires the detection notification message. The data accumulator 2 receives, from the application device 3, requests for search for the reference data by search meta data, for registration of new reference data, and for notification of the registration.

The data accumulator 2 includes a communication controller 2-1, an application manager 2-2, a data analyzer 2-3, a data buffer 2-4, application management storage 2-5, a pattern library 2-6, and a scheduler 2-7.

The communication controller 2-1 receives the event message from the monitor 1 so as to store the event message in the data buffer 2-4. The communication controller 2-1 provides a function which allows the application device 3, for remote control, to use the API provided by the application manager 2-2 for requesting search for the reference data by search meta data, registration of new reference data, and the notification of the registration. The above discussed function may be realized using such communication protocol as lava (trade mark) message service (EMS) and Simple Target object Access Protocol (SOAP).

The application manager 2-2 provides for the application device 3 the API for requesting search for the reference data, registration of new reference data, and the notification of the registration. In response to an instruction from the application device 3, the application manager 2-2 accesses data stored in the data accumulator 2 and controls the functional blocks.

The data analyzer 2-3 extracts sampled data from the data buffer 2-4 so as to analyze the sampled data in accordance with the data analysis logic and a parameter used in the data analysis logic, which are specified by the scheduler 2-7 or the application manager 2-2. The data analysis logics for sounds and images include various methods using statistical technique. Details of such methods are not the gist of the embodiments, thus the discussion thereof will be omitted. Fourier transformation, wavelet transformation, and singular value decomposition may be frequently used as the specific approach to the data analysis.

The data buffer 2-4 stores the sampled data transmitted from the monitor 1 in the form of the event message. FIG. 4 is a diagram illustrating an example of a data structure of a data buffer of a data accumulator according to an embodiment of the present invention. The data buffer 2-4 stores a sampling record, for each of the monitors 1, containing the sampled data. A sampling record stored in the data buffer 2-4 includes a monitor identifier (ID) field 2-4-1. The monitor ID field 2-4-1 contains a monitor ID capable of identifying a monitor. The sampling record stored in the data buffer 2-4 also includes, like as that of the monitor 1, a sampled data number field 2-4-2, a time stamp field 2-4-3, and a sampled data field 2-4-4. Also in the data accumulator 2, the sampling record is stored in the data buffer 2-4 for a predefined time period so that comparison of the sampled data in time-series may be performed.

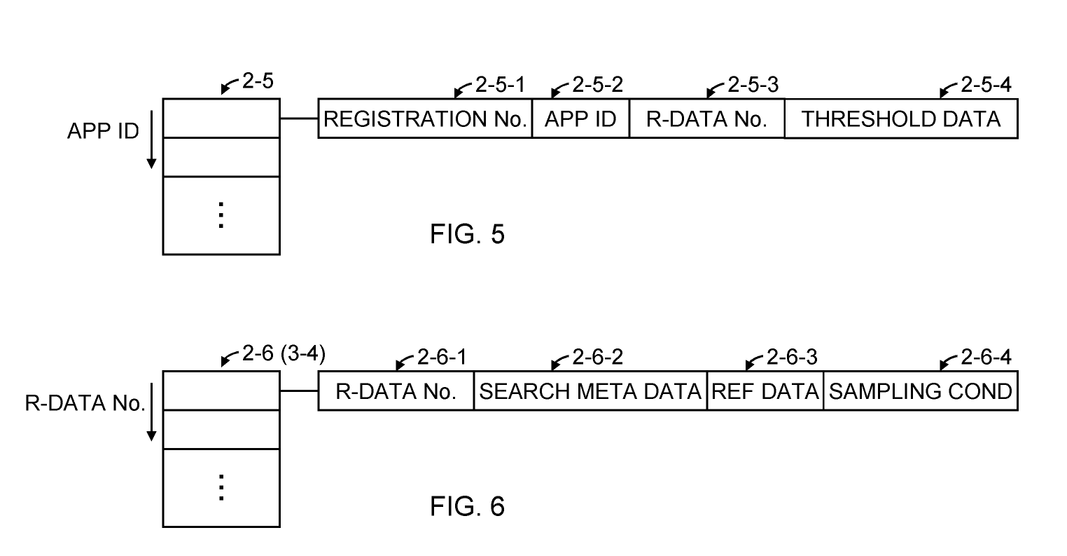

The application management storage 2-5 stores an application management record containing data for transmitting the detection notification message indicating the match between the sampled data and the reference data to the application device 3 that requires the detection notification message. FIG. 5 is a diagram illustrating an example of a data structure of an application management record stored in an application management storage of a data accumulator according to an embodiment of the present invention. The application management record stored in the application management storage 2-5 includes a registration number (denoted by “REGISTRATION No.” in the drawings) field 2-5-1, an application ID (denoted by “APP ID” in the drawings) field 2-5-2, a reference data number (denoted by “R-DATA No.” in the drawings) field 2-5-3, and threshold data field 2-5-4.

The registration number field 2-5-1 contains a registration number used as an identifier for ensuring consistency among the monitor 1, the data accumulator 2, and the application device 3.

The application ID field 2-5-2 contains an application ID which is an interface for transmitting the detection notification message upon the match of the sampled data. Generally, the name of a remote interface or a message reception queue may be contained in the application ID field 2-5-2.

The reference data number field 2-5-3 contains a reference data number indicating the reference data of the target object desired by the application device 3.

The threshold data field 2-5-4 contains a threshold data which allows ambiguity upon comparison with the sampled data. Data such as sounds or images is susceptible to the peripheral environment, and accordingly, it may be difficult to make strict comparison. Thus, the identifying granularity may be made ambiguous to a certain degree in order to ensure execution of the service.

The pattern library 2-6 stores a pattern record containing reference data used as a target template for comparison in detecting a specific target object in sound or video image data. FIG. 6 is a diagram illustrating an example of a data structure of a pattern record stored in a pattern library of a data accumulator according to an embodiment of the present invention. A pattern record stored in a pattern library 2-6 includes a reference data number field 2-6-1, a search meta data field 2-6-2, a reference data (denoted by “REF DATA” in the drawings) field 2-6-3, and a sampling condition (denoted by “SAMPLING COND” in the drawings) field 2-6-4.

The reference data number field 2-6-1 contains a reference data number used for pattern search in the pattern library 2-6.

The search meta data field 2-6-2 contains search meta data which is used by the operator to specify a target object. An example of the meta data is a target object name.

The reference data field 2-6-3 contains reference data generated by applying a specified data analysis logic on the target object.

The sampling condition field 2-6-4 contains sampling condition including the specified data analysis logic and parameter data used in the data analysis logic when detecting the target object.

The scheduler 2-7 periodically extracts data on a target object desired by the application device 3 from the application management storage 2-5 so as to extract, from the pattern library 2-6, the data analysis logic and the parameter used in detecting the target object. The scheduler 2-7 requests the data analyzer 2-3 to analyze the sampled data stored in the data buffer 2-4 in accordance with the data analysis logic and the parameter. The scheduler 2-7 compares analyzed data received from the data analyzer 2-3 with the reference data and sends the application device 3 a detection notification message when the analyzed data matches the reference data.

The application device 3 performs a specific action in response to detection of the target object identified as a specific sound or image. In the security service, for example, the application device 3 may provide a service for alerting the operator when an intruder has been detected.

The application device 3 includes a communication controller 3-1, a data analyzer 3-2, an application logic processor 3-3, and a pattern library 3-4.

The communication controller 3-1 provides a function which allows the application device 3, for remote control, to use the API provided by the monitor 1 or the data accumulator 2.

The data analyzer 3-2 directly collects the sampled data, which has not been fully analyzed by the data accumulator 2, from the monitor 1 so as to analyze the sampled data in detail.

The application logic processor 3-3 performs a process to be performed upon reception, from the data accumulator 2, of the detection notification message indicating that the specified target object has been detected. The application logic processor 3-3 also performs further detection of the target object by controlling the monitor 1, and provides graphical user interface (GUI) to the operator for communication with the monitor 1.

The data structure of a pattern record stored in the pattern library 3-4 is identical to that of the pattern library 2-6 illustrated in FIG. 6.

Operations of an embodiment of the present invention will be discussed in an example of automatic detection of an alarm sound generated by various devices.

The alarm sound differs depending on the devices. Thus it is preferable to confirm whether the target alarm sound to be detected has been registered in the data accumulator 2. In this example, it is assumed that the data accumulator 2 detects an alarm sound from a PC notifying completion of transfer of a large-sized file program or completion of a time-consuming batch process, and the application device 3 notifies the operator, at the remote location, of the alarm.

There are two cases for specifying the target object, that is, a first case of using a reference data pattern which has been already registered in the data accumulator 2, and a second case of registering a new reference data pattern. The first case will be discussed first.

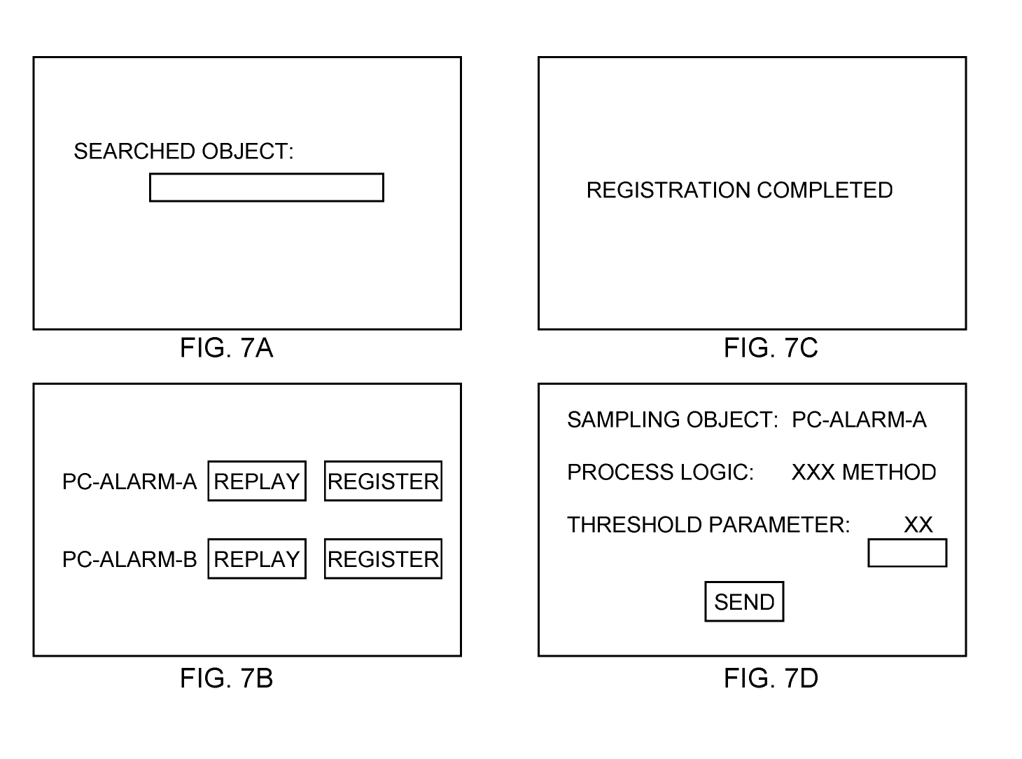

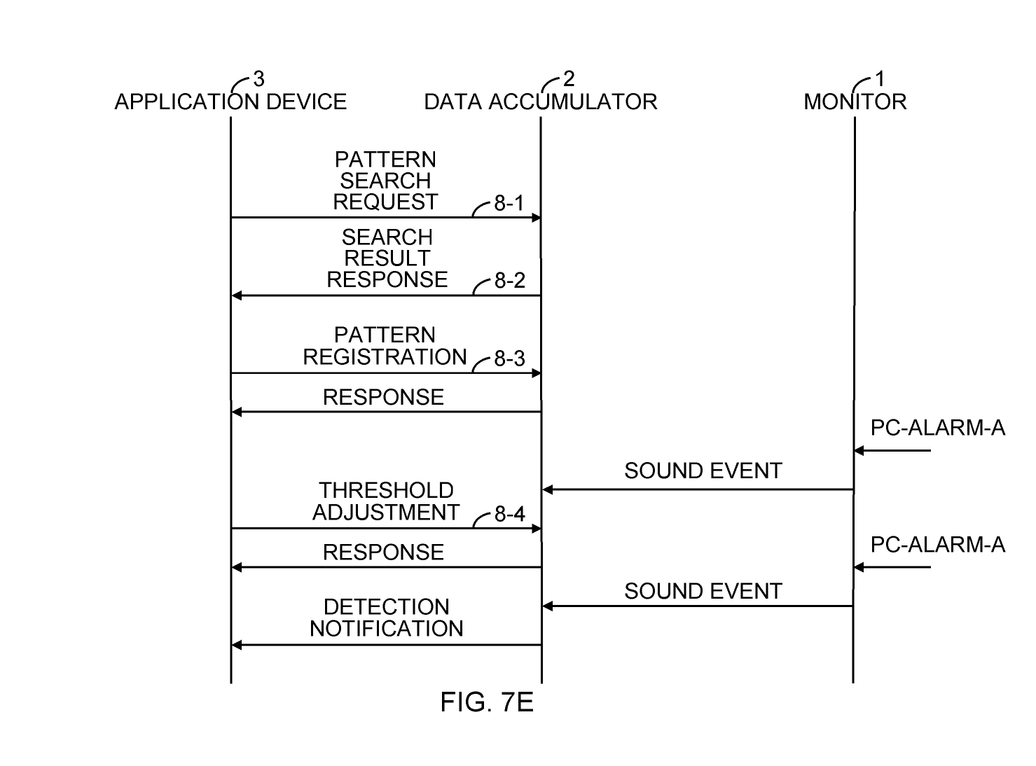

FIGS. 7A-7E are diagrams illustrating an example of a process for specifying a target object using a registered reference data pattern according to an embodiment of the present invention. FIG. 7A illustrates an example of a display screen for search input. FIG. 7B illustrates an example of a display screen displaying search result. FIG. 7C illustrates an example of a display screen after specifying the target object. FIG. 7D illustrates an example of a display screen for threshold adjustment. FIG. 7E illustrates an example of an operation flow of the process for specifying a target object using a registered reference data pattern.

The application logic processor 3-3 of the application device 3 provides a GUI for pattern search to the operator. In the GUI, for example, a box for specifying a target object name is displayed as illustrated in FIG. 7A. The application logic processor 3-3 remotely activates the search API of the data accumulator 2 via the communication controller 3-1 upon reception of the input. When the operator inputs a word “alarm”, the communication controller 3-1 transmits a pattern search request message 8-1 which contains search key data, that is, “alarm”.

Upon reception of the pattern search request message 8-1, the communication controller 2-1 of the data accumulator 2 activates the application manager 2-2 with a reference data analysis method. In response to the activation with the reference data analysis method, the application manager 2-2 searches the search meta data field 2-6-2 of the pattern records stored in the pattern library 2-6 for a character string which includes the word “alarm”. In the example, it is assumed that the search meta data field 2-6-2 contains preview reference data of the target object in addition to a character string which includes the target object name. It is further assumed that the “PC-ALARM-A” and the “PC-ALARM-B” are found as the result of the search.

The application manager 2-2 returns the reference data number, the target object name and the preview reference data of each reference data pattern as the response by the reference data analysis method. The communication controller 2-1 transmits the response by the reference data analysis method as a search result response message 8-2 to the communication controller 3-1 of the application device 3.

The communication controller 3-1 of the application device 3 sends the search result to the application logic processor 3-3. The application logic processor 3-3 displays, as illustrated in FIG. 7B for example, character strings of “PC-ALARM-A” and “PC-ALARM-B” as the search result, and “REPLAY” buttons for replaying each of the preview reference data as the GUI.

By depressing the “REPLAY” buttons, the operator confirms which sound is desired. It is assumed that the “PC-ALARM-A” is desired. The application logic processor 3-3 may provide “REGISTER” buttons on the GUI screen to allow the operator to have a registration. The operator depresses the “REGISTER” button corresponding to the “PC-ALARM-A” to specify the reference data for the target object. The communication controller 3-1 transmits a pattern registration message 8-3 which contains the application ID as the identification data of the addressee interface of the application device 3, and the reference data number of the reference data pattern selected by the operator.

Upon reception of the pattern registration message 8-3, the communication controller 2-1 of the data accumulator 2 activates the application manager 2-2 with a reference registration method. Upon activation with the reference registration method, the application manager 2-2 registers, in the application management storage 2-5, the application ID and the reference data number as input data for the reference registration method. Upon completion of the registration, the application manager 2-2 extracts from the pattern library 2-6 the sampling condition for the target object specified by the application device 3, and notifies the communication controller 2-1 of the extracted sampling condition and the registration number assigned to the application management record stored in the application management storage 2-5 upon registration, as the result of completing the reference registration method. The communication controller 2-1 returns a response message containing the sampling condition to the communication controller 3-1 of the application device 3.

The communication controller 3-1 of the application device 3 returns the response to the application logic processor 3-3. The application logic processor 3-3 displays a message indicating completion the registration on the GUI screen as illustrated in FIG. 7C.

Upon completion of the registration, the operator may be allowed to test whether the system actually detects the target sound. The application logic processor 3-3 of the application device 3 displays a GUI screen for the test sampling. The application logic processor 3-3 displays the registered target object and a threshold parameter which relates to the data analysis logic of the target object on the display screen as illustrated in FIG. 7D. The application logic processor 3-3 generates data to be displayed on the display screen with reference to the sampling condition notified from the data accumulator 2 as the result of the previous registration process.

Upon activation of the test sampling screen, the application logic processor 3-3 monitors reception of the detection notification message from the data accumulator 2. The detection notification process will be discussed later in detail. The operator causes a PC to output the alarm sound in front of the adjacent monitor 1 so as to confirm whether the application device 3 is notified of the alarm sound. If the notification is not performed, the operator changes the threshold parameter on the GUI screen for the test sampling illustrated in FIG. 7D.

The application logic processor 3-3 transmits a threshold adjustment message 8-4 to the data accumulator 2 via the communication controller 3-1. The threshold adjustment message 8-4 contains the registration number notified upon completion of the registration and the threshold data.

Upon reception of the threshold adjustment message 8-4, the communication controller 2-1 of the data accumulator 2 activates the application manager 2-2 with a threshold adjustment method. Upon activation with the threshold adjustment method, the application manager 2-2 searches the application management storage 2-5 for an application management record by the registration number as an input parameter, and updates the threshold data of the found application management record with the input threshold data. Upon completion of correcting the threshold value, the application manager 2-2 terminates the threshold adjustment method. The communication controller 2-1 notifies, via the communication controller 3-1, the application device 3 of the completion of adjustment.

Thereafter, the operator performs the test sampling to adjust the threshold value until the application device 3 receives the detection notification message.

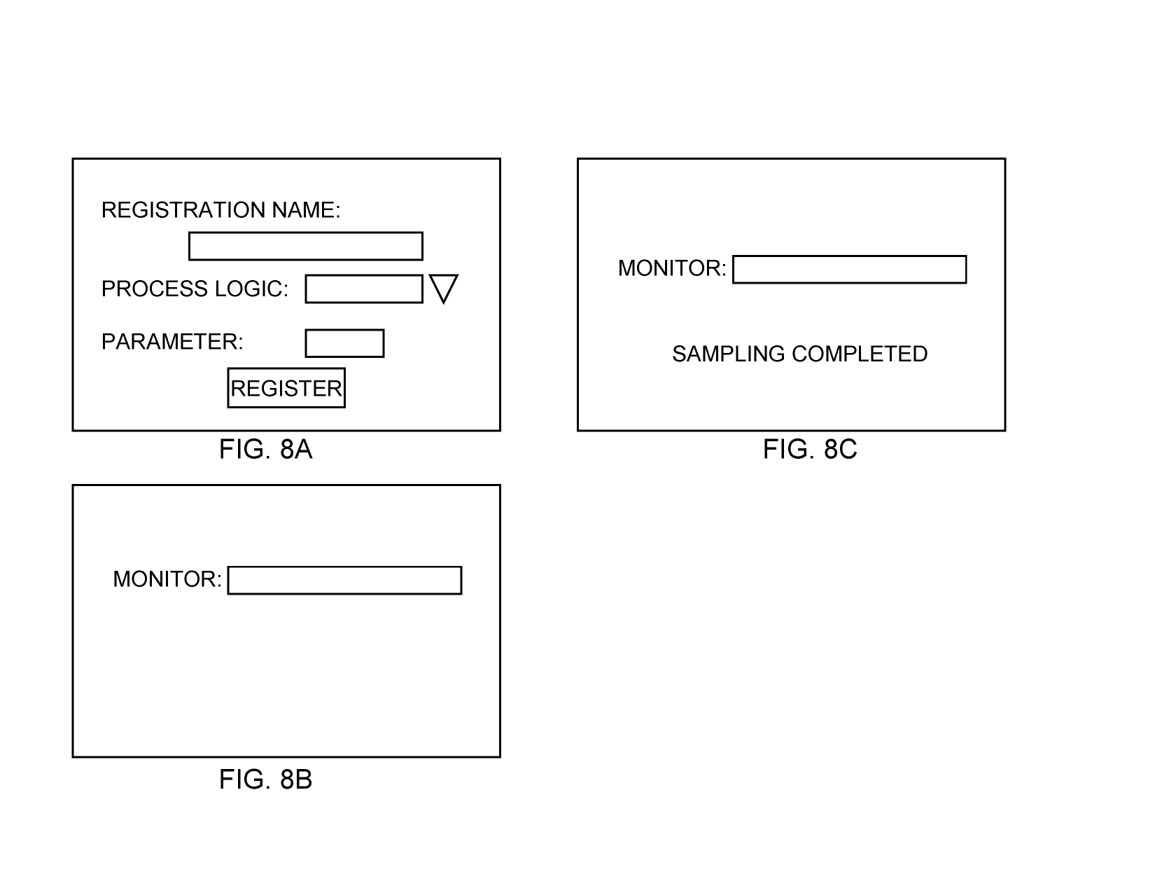

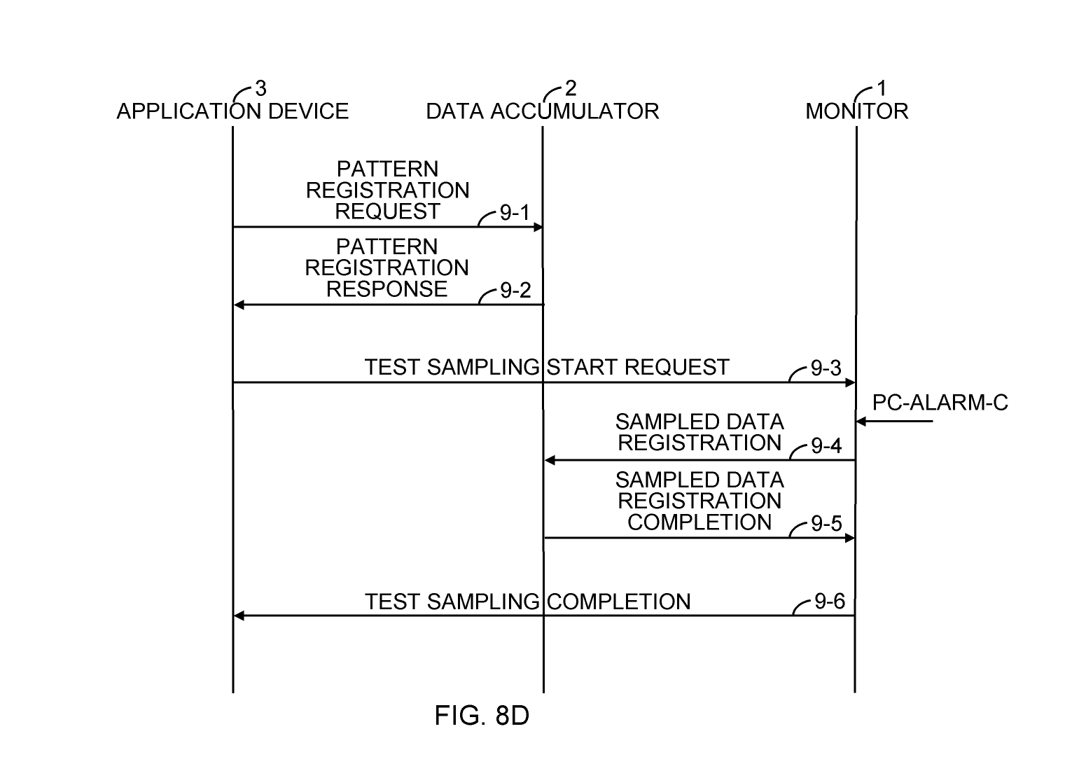

FIGS. 8A-8D are diagrams illustrating an example of a process for specifying a target object by registering a new reference data pattern according to an embodiment of the present invention. FIG. 8A illustrates an example of a display screen for pattern registration input. FIG. 8B illustrates an example of a display screen for test sampling. FIG. 8C illustrates an example of a display screen after test sampling. FIG. 8D illustrates an example of an operation flow of the process for specifying a target object by registering a new reference data pattern.

When the preview of the preview reference data of each reference data pattern included in the search result response message 8-2 shows that the sound desired by the operator is an alarm sound other than the “PC-ALARM-A” and “PC-ALARM-B”, the operator may register new sound data in the data accumulator 2.

The application logic processor 3-3 of the application device 3 provides a GUI for pattern registration to the operator. In the GUI, for example, a box for specifying a target object name, a list of data analysis logics each of which the data accumulator 2 may employ, and a box for specifying an adjustment parameter are displayed as illustrated in FIG. 8A. The operator may input, through the GUI, registration data such as a target object name to be registered, a data analysis logic to be employed, and an adjustment parameter used in the data analysis logic. It is assumed that the operator makes the pattern registration with the name of “PC-ALARM-C”. Upon completion of the input, the application logic processor 3-3 transmits, via the communication controller 3-1, a pattern registration request message 9-1 which contains the registration data.

Upon reception of the pattern registration request message 9-1, the communication controller 2-1 of the data accumulator 2 activates the application manager 2-2 with a pattern registration method. Upon activation with the pattern registration method, the application manager 2-2 assigns a reference data number for identifying the new reference data pattern and registers, in the pattern library 2-6, a pattern record containing the reference data number, a character string data for “PC-ALARM-C” as the search meta data, and the data analysis logic with the parameter used in the data analysis logic as the sampling condition.

The application manager 2-2 returns the assigned reference data number as the response by the pattern registration method. The communication controller 2-1 returns the response by the pattern registration method to the communication controller 3-1 of the application device 3 as a pattern registration response message 9-2.

The communication controller 3-1 of the application device 3 sends the registration result to the application logic processor 3-3. The application logic processor 3-3 transmits a test sampling start request message 9-3 to the monitor 1 which is used by the operator for registering the sound of the “PC-ALARM-C” via the communication controller 3-1. The test sampling start request message 9-3 contains the reference data number assigned by the data accumulator 2. The operator may specify the monitor 1 by, for example, inputting a device number assigned to the monitor 1 through the GUI provided by the application device 3 as illustrated in FIG. 8B.

Upon reception of the test sampling start request message 9-3 from the communication controller 3-1 of the application device 3, the communication controller 1-5 of the monitor 1 activates the application linker 1-7.

Upon reception of the test sampling start request, the application linker 1-7 temporarily stops normal data collection, and waits until occurrence of the sound to be sampled. Predefined values adjusted with the data accumulator 2 may be used as the sampling start condition and the sampling length. When the operator causes a PC to output an alarm sound, the application linker 1-7 collects the sound data via the data collector 1-1 in accordance with the above discussed conditions. Likewise the regular event data as discussed later, the digital sampling and filtering process are applied to the sound data. The codec data which may be replayed by a general PC are also collected as the preview reference data. The operator may cause the PC to output an alarm sound by operating the PC not only directly but also remotely.

Upon completion of the data sampling, the application linker 1-7 generates a sampled data registration message 9-4 to notify the data accumulator 2 of the sampled data registration message 9-4 via the communication controller 1-5. The sampled data registration message 9-4 contains the reference data number notified by the application device 3, digital data of the sampled sound, and the preview reference data.

Upon reception of the sampled data registration message 9-4, the data accumulator 2 activates the application manager 2-2 with a reference data registration method via the communication controller 2-1. Upon activation with the reference data registration method, the application manager 2-2 searches the pattern library 2-6 for a pattern record by the reference data number and activates the data analyzer 2-3 with the sampling condition contained in the found pattern record and the digital data of the sampled sound contained in the sampled data registration message 9-4 as input data.

The data analyzer 2-3 analyzes the digital data of the sampled sound using the specified data analysis logic and the specified parameter to generate data for comparison and notifies the application manager 2-2 of completion of data analysis.

Upon completion of the data analysis, the application manager 2-2 registers the data for comparison generated by the data analyzer 2-3 as the reference data in a corresponding pattern record stored in the pattern library 2-6. The application manager 2-2 also registers the preview reference data as the search meta data. Upon completion of the reference data registration, the application manager 2-2 transmits a sampled data registration completion message 9-5 to the monitor 1 via the communication controller 2-1.

Upon reception of the sampled data registration completion message 9-5 via the communication controller 2-1, the monitor 1 activates the application linker 1-7. The application linker 1-7 instructs the data collector 1-1 to resume the data collection, and generates a test sampling completion message 9-6 so as to notify the application device 3 of the test sampling completion message 9-6 via the communication controller 1-5.

Upon reception of the test sampling completion message 9-6 via the communication controller 3-1, the application device 3 activates the application logic processor 3-3 to display a message indicating the test sampling completion on the GUI screen as illustrated in FIG. 8C.

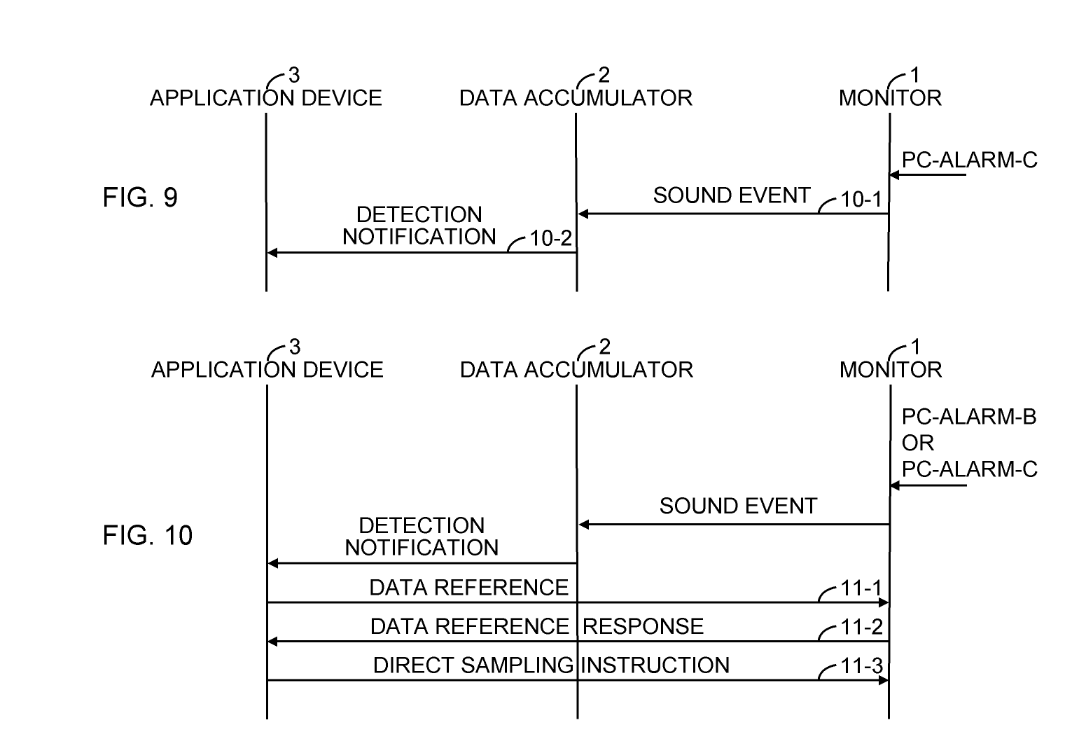

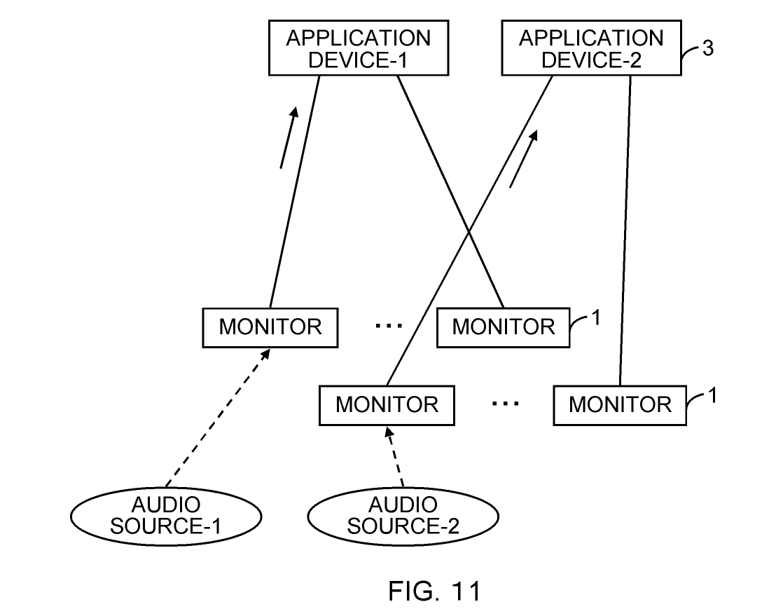

FIG. 9 is a diagram illustrating an example of an operation flow of a process for a sound data analysis performed by a data accumulator according to an embodiment of the present invention.

It is assumed that the operator completes registration of the “PC-ALARM-C” in the data accumulator 2, and starts a batch process on a PC before taking a rest in another room. Upon completion of the batch process, the PC generates an alarm sound indicating completion of the batch process. A microphone connected to the monitor 1 disposed near the PC picks up the sound and notifies the data collector 1-1 of the sound in the form of analog data. The data collector 1-1 executes analog to digital conversion in accordance with a reference value adjusted between the data collector 1-1 and the data accumulator 2.

The filter 1-2 removes redundant data from the digitized data. Filtered data is stored in a sampling record stored in the data buffer 1-6 along with a sampled data number and a time stamp which records the digitally sampled time. The data buffer 1-6 has a buffer length such that sampled data corresponding to, for example, one minute is stored. When buffering data causes buffer overflow, buffered data with oldest timestamp is discarded.

The event message generator 1-4 is activated at a predefined interval adjusted between the event message generator 1-4 and the data accumulator 2, and extracts sampled data that has been stored in the data buffer 2-4 after the previous activation to generate a sound event message 10-1. The sound event message 10-1 contains a monitor ID, the sampled data number, the time stamp, and the sampled data. The event message generator 1-4 transmits the sound event message 10-1 to the data accumulator 2 via the communication controller 1-5.

Upon reception of the sound event message 10-1 from the monitor 1, the communication controller 2-1 of the data accumulator 2 stores the sampled data number, the time stamp, and the sampled data contained in the sound event message 10-1 in a sampling record, stored in the data buffer 2-4, having the monitor ID contained in the sound event message 10-1. The sampling record stored in the data buffer 2-4 of the data accumulator 2 has an identical data structure to that of the sampling record stored in the data buffer 1-6 of the monitor 1 except that the sampling record stored in the data buffer 2-4 further includes the monitor ID field 2-4-1.

The scheduler 2-7 is activated at a predefined interval to extract a reference data number contained in each application management record stored in the application management storage 2-5. The scheduler 2-7 then extracts reference data and a sampling condition from a pattern record, which is stored in the pattern library 2-6, having the extracted reference data number.

The scheduler 2-7 specifies a sampling condition and a sampling start time to request the data analyzer 2-3 to analyze sampled data.

The data analyzer 2-3 extracts sampled data contained in a sampling record having a time stamp recorded after the specified sampling start time from the data buffer 2-4, and analyzes the sampled data using the data analysis logic and the parameter specified as the sampling condition. Upon completion of the analysis, the data analyzer 2-3 notifies the scheduler 2-7 of the analyzed data.

The scheduler 2-7 determines whether the analyzed data matches the reference data. It is assumed that a difference within a value specified by the threshold data is allowed to be neglected. When the analyzed data matches the reference data, a detection notification message 10-2 addressed to application ID contained in the application management record stored in the application management storage 2-5 is generated so as to notify the application device 3 the detection notification message 10-2 via the communication controller 2-1.

Upon reception of the detection notification message 10-2 via the communication controller 3-1, the application device 3 activates the application logic processor 3-3.

Upon reception of the detection notification message 10-2, the application logic processor 3-3 provides a certain service. In the embodiment, the application logic processor 3-3 may generate a mail indicating completion of the batch process so as to send the mail to a mobile phone of the operator who takes a rest in the other room.

FIG. 10 is a diagram illustrating an example of an operation flow of a process for a detailed sound data analysis performed by an application device according to an embodiment of the present invention.

In the embodiment discussed above, the operator registers the “PC-ALARM-C”. When alarm pattern of the “PC-ALARM-C” is similar to that of the “PC-ALARM-B”, the use of a relatively loose threshold value may increase the misidentification rate of the data accumulator 2 because the data accumulator 2 may take the “PC-ALARM-B” for the “PC-ALARM-C”. On the contrary, the data accumulator 2 may fail to detect the “PC-ALARM-C” with a severe threshold value. In the case where the misidentification is caused by a peripheral environment around the sound source or by a similar sound source, it may be preferable that a loose threshold value is set in the data accumulator 2 and that the application device 3 performs detailed analysis while directly communicating with the monitor 1 so as to discriminate the “PC-ALARM-C” from the “PC-ALARM-B”.

Upon reception of the detection notification message 10-2, in the operation flow illustrated in FIG. 9, the application logic processor 3-3 of the application device 3 may transmit a data reference message 11-1 to the monitor 1. The data reference message 11-1 is transmitted to the monitor 1 via the communication controller 3-1. The data reference message 11-1 contains the sampled data number of the detected data notified by the detection notification message 10-2 and a data investigation range (range from data sampled before the detected data to data sampled after the detected data).

Upon reception of the data reference message 11-1 from the application device 3 via the communication controller 1-5, the monitor 1 activates the application linker 1-7.

The application linker 1-7 extracts sampled data from the data buffer 1-6 in accordance with the reference data number and the data investigation range specified in the data reference message 11-1, and stores extracted sampled data in a data reference response message 11-2, which is sent in response to the data reference message 11-1, so as to transmit the data reference response message 11-2 to the application device 3 via the communication controller 1-5.

Upon reception of the data reference response message 11-2 via the communication controller 3-1, the application device 3 activates the application logic processor 3-3.

The application logic processor 3-3 sends the sampled data notified by the data reference response message 11-2 to the data analyzer 3-2 together with the sampling condition contained in the pattern record stored in the pattern library 3-4.

The data analyzer 3-2 analyzes the sampled data in accordance with the sampling condition. Upon completion of the analysis, the data analyzer 3-2 sends the analyzed sampled data to the application logic processor 3-3.

The application logic processor 3-3 compares the analyzed sampled data with the reference data contained in the pattern record stored in the pattern library 3-4 by using a loose threshold value. In the embodiment, the pattern matching of the analyzed sampled data with “PC-ALARM-B” and “PC-ALARM-C”, respectively, may be performed, and the one with the higher identification rate may be identified as a sound source.

The reference data registered in the pattern library 3-4 may be transmitted from the data accumulator 2 to the application logic processor 3-3 when the registration of the reference data is completed in the operation flow of FIGS. 7A-7E and FIGS. 8A-8D. This allows the application device 3 to avoid generation of the template of the reference data individually.

Inadequacy of the parameter which relates to the data collection of the monitor 1 may be another reason why the sound source may not be identified. For example, if the sensitivity of the microphone is low, the sound source may not be identified. In such a case, the sound source may be identified by increasing the sensitivity level of the microphone. When the sampled data buffered by the monitor 1 are insufficient for the analysis, the application device 3 may instruct the monitor 1 to perform the direct sampling.

When the direct sampling is needed, the application device 3 presents a function for enabling the operation on the GUI screen to the operator, or executes the operation as a part of the service execution process of the application logic processor 3-3.

In either case, the application logic processor 3-3 of the application device 3 generates a direct sampling instruction message 11-3 to be transmitted to the monitor 1 via the communication controller 3-1. The direct sampling instruction message 11-3 contains a parameter, sensitivity of the microphone for example, which relates to the API provided by the sensor controller 1-3.

Upon reception of the direct sampling instruction message 11-3 from the application device 3 via the communication controller 1-5, the monitor 1 activates the application linker 1-7.

The application linker 1-7 controls, through the API of the sensor controller 1-3, a connected equipment in accordance with the parameter specified in the direct sampling instruction message 11-3.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An object detection method executed by an object detection system for detecting data corresponding to a specific object in data received from sensors, the object detection system including a plurality of monitors, an application device, and a data accumulator, the object detection method comprising:
specifying, by the application device, reference data corresponding to the specific object;
sampling, by each of the plurality of monitors, data received from a sensor to generate and transmit sampled data;
analyzing, by the data accumulator, sampled data received from each of the plurality of monitors in accordance with an analysis logic to generate first analyzed data;
determining, by the data accumulator, whether the first analyzed data matches the reference data specified by the application device, and
transmitting, by the data accumulator, a detection notification indicating detection of the specific object to the application device when first analyzed data generated from sampled data received from a first monitor out of the plurality of monitors has matched the reference data.

2. The object detection method of claim 1, further comprising:
storing, by the data accumulator, a plurality of reference data, each of the plurality of reference data being correlated with meta data capable of identifying the each of the plurality of reference data;
specifying, by the application device, meta data to the data accumulator;
searching, by the data accumulator, for reference data correlated with meta data specified by the application device; and
transmitting, by the data accumulator, search result to the application device.

3. The object detection method of claim 1, further comprising:
registering, by the application device, a new reference data to the data accumulator.

4. The object detection method of claim 1, further comprising:
analyzing in detail, by the application device, the sampled data received from the first monitor, the first monitor being identified with a monitor identifier contained in the detection notification.

5. The object detection method of claim 4, wherein
the application device operates a sensor managed by the first monitor to collect sampled data in the operation of analyzing in detail.

6. An object detection system for detecting data corresponding to a specific object in data received from sensors, the object detection system comprising:
a plurality of monitors each for sampling data received from a sensor to generate and transmit sampled data;
an application device including an application logic processor for specifying reference data corresponding to the specific object; and
a data accumulator including:
a first data analyzer for analyzing sampled data received from each of the plurality of monitors in accordance with an analysis logic to generate first analyzed data,
a scheduler for determining whether the first analyzed data matches the reference data specified by the application device, and
a first communication controller for transmitting a detection notification indicating detection of the specific object to the application device when first analyzed data generated from sampled data received from a first monitor out of the plurality of monitors has matched the reference data.

7. The object detection system of claim 6,
the data accumulator further including:
a pattern library for storing a plurality of reference data, each of the plurality of reference data being correlated with meta data capable of identifying the each of the plurality of reference data, and
an application manager for searching for reference data correlated with meta data specified by the application device,
wherein
the first communication controller of the data accumulator transmits search result to the application device.

8. The object detection system of claim 7, wherein
the search result includes the meta data specified by the application device and the reference data correlated with meta data specified by the application device.

9. The object detection system of claim 6,
the application device further including a second communication controller for transmitting a test sampling request to a second monitor out of the plurality of monitors,
wherein
the second monitor
samples data received from a sensor to generate test sampled data, and transmits the test sampled data to the data accumulator,
the application logic processor of the application device
specifies meta data and a first analysis logic to the data accumulator, the meta data being capable of identifying the specific object, the first analysis logic being used for analyzing sampled data corresponding to the specific object, and
the first data analyzer of the data accumulator analyzes the test sampled data in accordance with the first analysis logic to generate reference data for the specific object.

10. The object detection system of claim 6, wherein
the scheduler of the data accumulator determines whether the first analyzed data matches the reference data within a predefined threshold of difference.

11. The object detection system of claim 6,
the application device further including:
a second data analyzer for analyzing sampled data received from the first monitor in accordance with the analysis logic to generate second analyzed data, the analysis logic being received from the data accumulator,
wherein
the application logic processor of the application device determines whether the second analyzed data matches the reference data received from the data accumulator.

12. A data accumulator for detecting data corresponding to a specific object in sampled data received from a plurality of monitors and notifying an application device of detection, the data accumulator comprising:
a data analyzer for analyzing sampled data received from each of the plurality of monitors in accordance with an analysis logic to generate analyzed data;
a scheduler for determining whether the analyzed data matches reference data for the specific object, the reference data being specified by the application device; and
a communication controller for transmitting a detection notification indicating detection of the specific object to the application device when analyzed data generated from sampled data received from a monitor out of the plurality of monitors has matched the reference data.
